(19) United States
(12) Patent Application Publication
(10) Pub. No.: US 2014/0348012 A1
(43) Pub. Date: Nov. 27, 2014

(54) SMALL CELL COMMUNICATION SYSTEM AND OPERATING METHOD THEFEOF

(71) Applicant: HTC CORPORATION, Taoyuan City (TW)

(72) Inventor: Chih-Yao WU, Taoyuan City (TW)

(73) Assignee: HTC CORPORATION, Taoyuan City (TW)

(21) Appl. No.: 14/288,229

(22) Filed: May 27, 2014

Related U.S. Application Data
(60) Provisional application No. 61/827,676, filed on May 27, 2013.

(51) Int. Cl. H04W 24/08

(52) U.S. Cl. CPC H04W 24/08
USPC 370/252

(57) ABSTRACT

A small cell communication system and an operating method thereof are provided. The small cell communication system comprises a base station and a mobile device. The base station is configured to determine a reference signal pattern from a plurality of reference signal patterns, determine a physical resource block (PRB) bundling size corresponding to the reference signal pattern and transmit a signal with the PRB bundling size and the reference signal pattern. The mobile device is configured to receive the signal and perform channel estimation according to the PRB bundling size and the reference signal pattern. The operating method is applied to the small cell communication system to implement the aforesaid operations.

This application claims priority to U.S. Provisional Patent Application No. 61/827,676 filed on May 27, 2013, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a small cell communication system and an operating method thereof. More specifically, the present invention relates to a small cell communication system and an operating method thereof in regard to channel estimation.

2. Descriptions of the Related Art

Small cell deployment with low power transmission nodes (pico cell, femto cell, etc) for hotspot zone has drawn a lot of interests on the next generation of wireless communication systems and standards (e.g. LTE-advanced). Under this deployment, mobile devices served by small cells are expected to suffer from lower path loss and therefore enjoy better channel gain. In addition, the small cells have smaller cell coverage compared to typical base stations so that the channel delay spread to the small cells is usually smaller than that to typical base stations. In other words, the channel coherence bandwidth to the small cells will become larger. As a result, the wireless channels of the small cells are considered to be more time-invariant and frequency-invariant.

To improve the spectral efficiency of small cells, reducing reference signals on frequency domain to release more physical resources for data transmission is regarded as a potential method. However, a large portion of reference signal reduction may harm the channel estimation performance. Therefore, there is a tradeoff between channel estimation accuracy and spectral efficiency improved by reducing reference signals under small cell deployment. In view of this, it is important in the art to provide a method to balance channel estimation accuracy and spectral efficiency improved by reducing reference signals under small cell deployment.

### SUMMARY OF THE INVENTION

The primary objective of this invention is to provide an approach to balance channel estimation accuracy and spectral efficiency improved by reducing reference signals under small cell deployment.

In accordance with an aspect of the present invention, there is provided a small cell communication system. The small cell communication system comprises a base station and a mobile device. The base station is configured to determine a reference signal pattern from a plurality of reference signal patterns, determine a physical resource block (PRB) bundling size corresponding to the reference signal pattern and transmit a signal with the PRB bundling size and the reference signal pattern. The mobile device is configured to receive the signal and perform channel estimation according to the PRB bundling size and the reference signal pattern.

In accordance with an aspect of the present invention, there is provided an operating method for a small cell communication system. The small cell communication system comprises a base station and a mobile device. The operating method comprises the following steps: determining a reference signal pattern from a plurality of reference signal patterns by the base station; determining a physical resource block (PRB) bundling size corresponding to the reference signal pattern by the base station; transmitting a signal with the PRB bundling size and the reference signal pattern by the base station; receiving the signal by the mobile device; and performing channel estimation according to the PRB bundling size and the reference signal pattern by the mobile device.

In conclusion, the present invention provides a novel approach to associate an adaptive PRB bundling size with a reference signal pattern for channel estimation. Whether the reference signal pattern indicates the reduction of reference signals due to the improvement of spectral efficiency or indicates the increase of reference signals due to improvement of channel estimation, a suitable PRB bundling size can be determined to correspond to the reference signal pattern in a proper way. Besides, if the reference signal pattern indicates that the distribution of reference signals is changed without decreasing or increasing the amount of reference signals, a suitable PRB bundling size can be determined to correspond to the reference signal pattern in a proper way. Therefore, the present invention can effectively balance channel estimation accuracy and spectral efficiency improved by reducing reference signals under small cell deployment.

The present invention also implies other benefits. For example, if a reference signal pattern indicates the reduction of reference signals, some signals indicating the reduction are inevitable to be transmitted to the corresponding mobile device so that no additional signal overhead is required as the proposed approach is applied. In addition, the channel estimation can be improved by enlarging of the PRB bundling size if the reduction of reference signals is made due to the improvement of spectral efficiency.

The detailed technology and preferred embodiments implemented for the present invention are described in the following paragraphs accompanying the appended drawings for persons skilled in this art to well appreciate the features of the claimed invention.

### BRIEF DESCRIPTION OF THE DRAWINGS

FIG. 1 is a schematic view illustrating the architecture of a small cell communication system according to an embodiment of the present invention;

FIG. 2A is a schematic view illustrating a reference signal pattern according to 3GPP TS 36.211, V11.2.0, 2013-02;

FIG. 2B is a schematic view illustrating another reference signal pattern comprising fewer reference signals compared to the reference signal pattern of FIG. 2A;

FIG. 2C is a schematic view illustrating yet another reference signal pattern comprising more reference signals compared to the reference signal pattern of FIG. 2A; and

FIG. 3 is a flowchart diagram of an operating method for a small cell communication system according to an embodiment of the present invention.

### DESCRIPTION OF THE PREFERRED EMBODIMENT

The present invention can be explained with reference to the following embodiments. However, these embodiments are not intended to limit the present invention to any specific environments, applications or implementations described in these embodiments. Therefore, the description of these embodiments is only for the purpose of illustration rather than to limit the present invention. In the following embodiments and attached drawings, elements not directly related to the present invention are omitted from depiction. The dimensional relationships among individual elements in the attached drawings are illustrated only for ease of understanding but not to limit the actual scale.

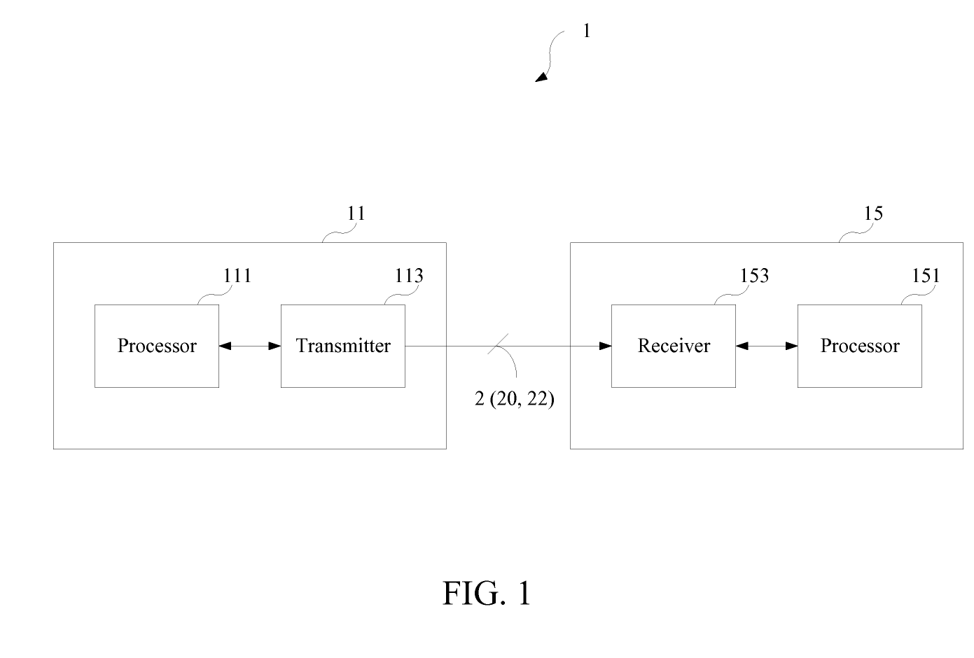

An embodiment of the present invention is as shown in FIG. 1, which depicts the architecture of a small cell communication system 1. The small cell communication system 1 may be any communication system conforming to small cell deployment, and it can be generally carried out under any wireless communication standard without departing from the spirit of the present invention. For example, the small cell communication system 1 may be carried out under the Long Term Evolution (LTE) standard, the LTE-advanced standard, etc.

As shown in FIG. 1, the small cell communication system 1 comprises at least one base station 11 (i.e., one or more base stations) and at least one mobile device 15 (i.e., one or more mobile devices). The base station 11, for example, may be an eNodeB as defined in the LTE-advanced standard. The mobile device 15, for example, may be a UE as defined in the LTE-advanced standard. The base station 11 may comprise a processor 111 and a transmitter 113, while the mobile device 15 may comprise a processor 151 and a receiver 153. The processor 111 is coupled with the transmitter 113 directly or indirectly to communicate with each other, while the processor 151 is coupled with the transmitter 153 directly or indirectly to communicate with each other.

At the base station 11, the processor 111 is configured to determine a reference signal pattern 20 from a plurality of reference signal patterns and determine a physical resource block (PRB) bundling size 22 corresponding to the reference signal pattern 20. Specifically, the processor 111 may determine the reference signal pattern 20 based on at least the characteristic of the wireless channel between the base station 11 and the mobile device 15. The characteristic of the wireless channel can be obtained at the base station 11 by the channel state information (CSI) feedback of the mobile device 15. Other than the channel state information (CSI) feedback of the mobile device 15, the base station 11 may also obtain the characteristic of the wireless channel by other well-known methods.

The reference signal pattern 20 is used to indicate which resource element(s) is used for reference signal transmission in each PRB. The reference signal pattern 20 could indicate the amount (i.e., quantity) of reference signals used in one PRB or how many reference signals used in one PRB. Additionally, the reference signal pattern 20 could indicate the distribution (i.e. location) of the reference signals in the PRB, or how the reference signals locate in the PRB. For example, the reference signal pattern 20 may be a UE-specific reference signal pattern as defined in the LTE-advanced standard.

The PRB bundling size 22 is used to indicate how many PRBs are bundled with the same precoding. In other words, PRB bundling means the precoding granularity or the transmission power granularity is multiple resource blocks in the frequency domain. For example, the PRB bundling size 22 may be a precoding resource block group (PRG) size as defined in the LTE-advanced standard. Different from conventional small cell communication systems, the PRB bundling size 22 is determined depending on the reference signal pattern 20, or vice versa. Accordingly, the present invention can balance channel estimation accuracy and spectral efficiency improved by reducing reference signals under small cell deployment.

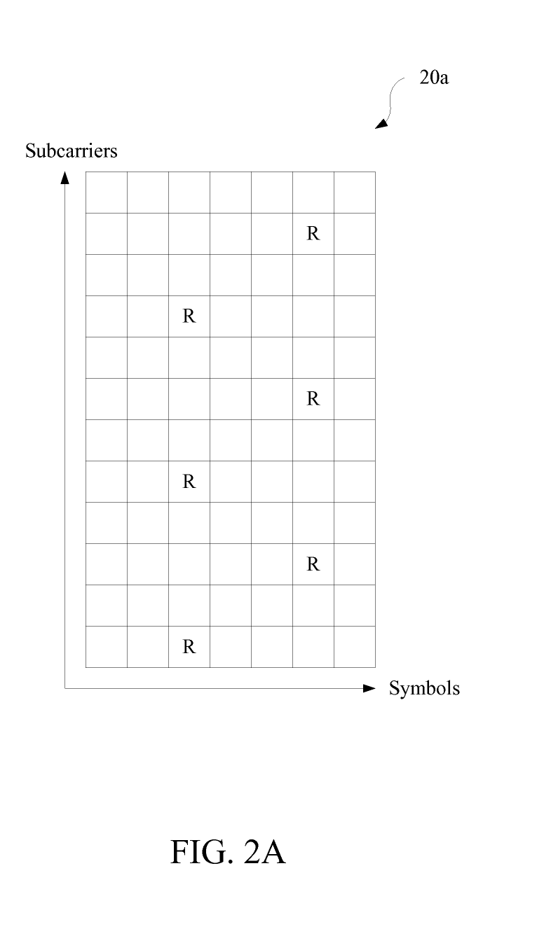

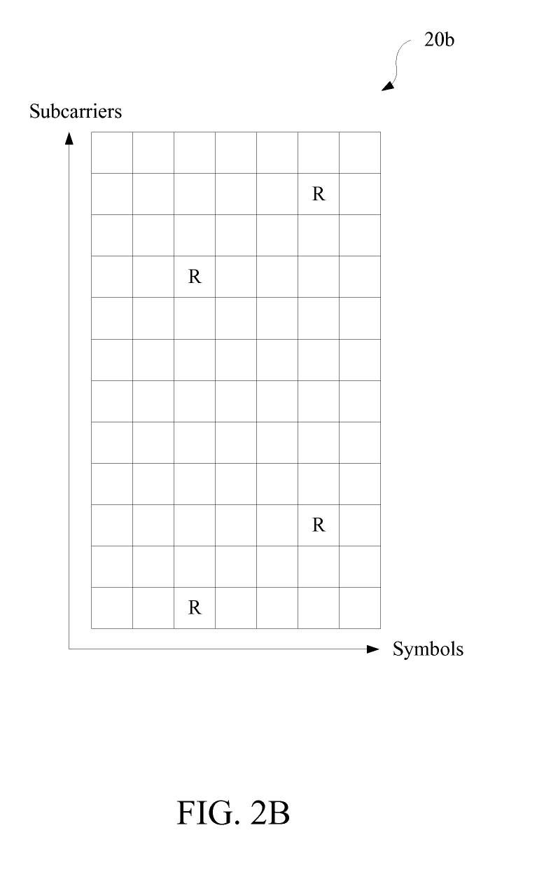

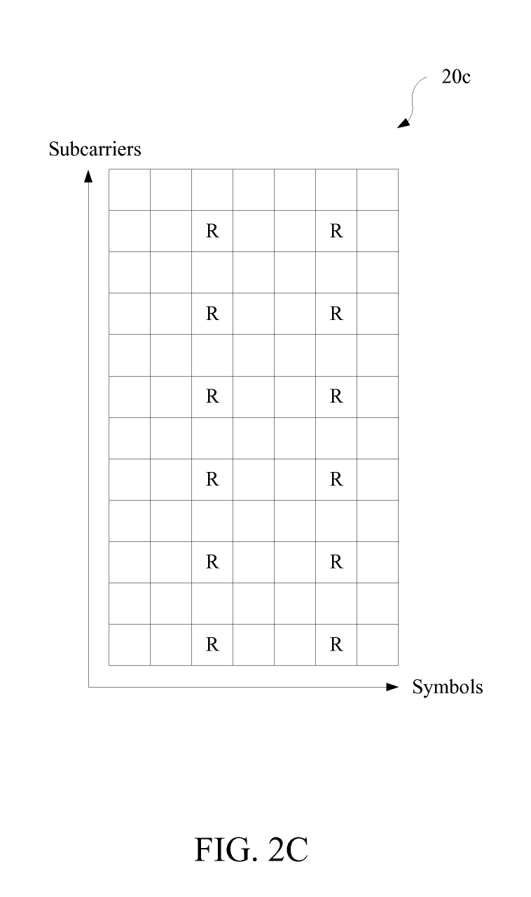

With reference to FIGS. 2A-2C as an example, the way in which the processor 111 determines the PRB bundling size 22 and its corresponding reference signal pattern 20 will be described in detail. In this example, the reference signal pattern 20 may indicate the amount of reference signals in one PRB and the PRB bundling size 22 is at least one PRB. Alternatively, PRB bundling size 22 is at least two PRBs.

FIG. 2A is a schematic view illustrating a reference signal pattern 20a according to 3GPP TS 36.211, V11.2.0, 2013-02, FIG. 2B is a schematic view illustrating another reference signal pattern 20b comprising fewer reference signals compared to the reference signal pattern of FIG. 2A, and FIG. 2C is a schematic view illustrating yet another reference signal pattern 20c comprising more reference signals compared to the reference signal pattern of FIG. 2A.

As shown in FIG. 2A, the reference signal pattern 20a indicates that one PRB is composed of eighty-four resource elements and six resource elements noted as R are used for reference signal transmission. It is assumed that the reference signal pattern 20a is suitable for the current wireless channel between the base station 11 and the mobile device 15.

In a case where the current wireless channel gets better, the processor 111 may reduce the number of the reference signals to release more physical resources for data transmission as shown in FIG. 2B. At the meantime, the processor 111 may enlarge the PRB bundling size 22 to avoid harming the channel estimation performance. For example, if a LTE-advanced standardized system bandwidth includes 27-63 PRBs, the PRB bundling size 22 may change from three to four. That is, four consecutive PRBs instead of three consecutive PRBs are bundled with the same precoding. Basically, the less the reference signal is used in one PRB, the more the PRB could be bundled. On the other hand, the more the PRB could be bundled, the less the reference signal is used in one PRB.

In another embodiment, the processor 111 may also maintain the PRB bundling size 22 if the reduction of reference signals, for example, does not substantially harm the channel estimation performance.

In another case where the current wireless channel gets worse, the processor 111 may increase the number of the reference signals to obtain more physical resources for channel estimation as shown in FIG. 2C. At the meantime, the processor 111 may diminish the PRB bundling size 22 to reduce unnecessary estimation complexity. For example, if a LTE-advanced standardized system bandwidth includes 27-63 PRBs, the PRB bundling size 22 may change from three to two. That is, two consecutive PRBs instead of three consecutive PRBs are bundled with the same precoding. Basically, the more the reference signal is used in one PRB, the less the PRB could be bundled. On the other hand, the less the PRB could be bundled, the more the reference signal is used in one PRB. In another embodiment, the processor 111 may also maintain the PRB bundling size 22 if the increase of references signals, for example, is still not enough to improve the channel estimation.

In another embodiment, whether the current channel gets better or worse, the processor 111 may just change the distribution (i.e. location) of reference signals in each PRB without decreasing or increasing the number of reference signals. In this condition, the processor 111 may change the PRB bundling size 22 according to the changed distribution of reference signals. In other words, the PRB bundling size may be determined according to the distribution of reference signals.

Based on the above operations, the base station 11 decides at least one combination of the reference signal pattern 20 and the PRB bundling size 22 for the mobile device 15. The combinations of the reference signal pattern 20 and the PRB bundling size 22 may be predetermined or determined dynamically. One example of such combinations is shown in the following table.

As shown in the following table, it is possible for several reference signal patterns 20 to share the same PRB bundling size 22. For example, if the system bandwidth comprises 11-26 PRBs, the PRB bundling size 22 is determined to be two for the first reference signal pattern 20 and the second reference signal pattern 20, and determined to be four for the third reference signal pattern 20 and the fourth reference signal pattern 20. In this example, the first reference signal pattern 20 and the second reference signal pattern 20 each may have the amount of reference signals more than each of the third reference signal pattern 20 and the fourth reference signal pattern 20.

PRB bundling size 22

| | First | Second | third | fourth |
|---|---|---|---|---|
| System | reference | reference | reference | reference |
| bandwidth | signal | signal | signal | signal |
| (PRBs) | pattern 20 | pattern 20 | pattern 20 | pattern 20 |
| 10 | 1 | 1 | 2 | 2 |
| 11-26 | 2 | 2 | 4 | 4 |
| 27-63 | 3 | 3 | 6 | 6 |
| 64-110 | 2 | 2 | 4 | 4 |

After the processor 111 determines a reference signal pattern 20 and its corresponding PRB bundling size 22, the transmitter 113 transmits a signal 2 with the PRB bundling size 22 and the reference signal pattern 20 to the mobile device 15 for channel estimation. The signal 2 may be a higher layer signal (e.g., radio resource control (RRC) message) or a physical layer signal (e.g., bits in downlink control information (DCI)) as defined in the LTE-advanced standard. After transmitting the signal 2, the transmitter 113 may execute the corresponding MIMO precoding operation for data packets based on the determined PRB bundling size 22 and transmits the data packets with the defined reference signal pattern 20 to the mobile device 15.

In another embodiment, the processor 111 may further assign a specific index to each combination of one reference signal pattern 20 and its corresponding PRB bundling size 22, and the transmitter 113 transmits the signal 2 which contains the corresponding specific index to the mobile device 15 for channel estimation.

At the mobile device 15, the receiver 153 is configured to receive various signals/data packets from the base station 11. Therefore, after the receiver 153 receives the signal 2, the mobile device 15 can obtain the information carried by the signal 2, which includes the determined reference signal pattern 20 and its corresponding PRB bundling size 22. Next, the processor 151 performs channel estimation according to the determined reference signal pattern 20 and its corresponding PRB bundling size 22.

More specifically, the processor 151 does the channel estimation by using the determined reference signal pattern 20 across all (or several) PRBs based on the corresponding PRB bundling size 22. For example, if the signal 2 indicates that the corresponding PRB bundling size 22 is three, the processor 151 does the channel estimation by using the determined reference signal pattern 20 across three PRBs. As another example, if the signal 2 indicates that the corresponding PRB bundling size 22 is one, the processor 151 does the channel estimation by using the determined reference signal pattern 20 over one PRB.

Furthermore, the processor 151 may execute channel interpolation according to the determined reference signal pattern 20 and its corresponding PRB bundling size 22 to perform the channel estimation. For example, by utilizing a two-dimensional interpolation filter, the processor 151 executes the channel interpolation across all (or several) PRBs based on the corresponding PRB bundling size 22 to perform the channel estimation. Upon the completion of the channel estimation, the processor 151 uses the estimated channel for subsequent data packet demodulation.

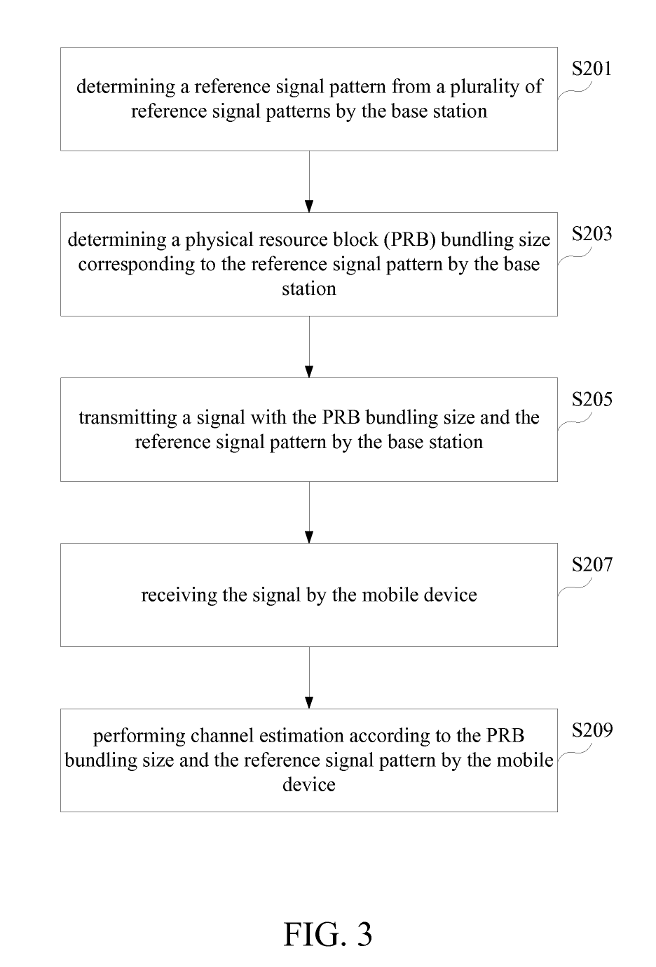

An embodiment of the present invention is as shown in FIG. 3, which depicts an operating method for a small cell communication system. The operating method of this embodiment may be applied to the small cell communication system 1 as described in the preceding embodiments.

As shown in FIG. 3, a step S201 is executed for determining a reference signal pattern from a plurality of reference signal patterns by the base station, a step S203 is executed for determining a physical resource block (PRB) bundling size corresponding to the reference signal pattern by the base station, a step S205 is executed for transmitting a signal with the PRB bundling size and the reference signal pattern by the base station, a step S207 is executed for receiving the signal by the mobile device, and a step S209 is executed for performing channel estimation according to the PRB bundling size and the reference signal pattern by the mobile device. Note that the order of these steps is not a limitation to the present invention, and can be adjusted without departing from the spirit of the present invention.

In another embodiment, the reference signal pattern indicate the amount of reference signals in one PRB and the PRB bundling size is at least one PRB. In addition, the less the reference signal is used in one PRB, the more the PRB is bundled.

In another embodiment, the reference signal pattern indicate the amount of reference signals in one PRB and the PRB bundling size is at least two PRB. In addition, the less the reference signal is used in one PRB, the more the PRB is bundled.

In another embodiment, the reference signal pattern indicate the amount of reference signals in one PRB and the PRB bundling size is at least one PRB. In addition, the more the reference signal is used in one PRB, the less the PRB is bundled.

In another embodiment, the reference signal pattern indicate the amount of reference signals in one PRB and the PRB bundling size is at least two PRB. In addition, the more the reference signal is used in one PRB, the less the PRB is bundled.

In another embodiment, the reference signal pattern indicates the distribution of reference signals and the PRB bundling size is determined according to the distribution of reference signals.

In another embodiment, the step S209 may further comprise the following step: executing channel interpolation according to the reference signal pattern and the PRB bundling size by the mobile device to perform the channel estimation.

In addition to the aforesaid steps, the operating method of this embodiment can also execute all the operations of the small cell communication system 1 set forth in the preceding embodiments and accomplish all the corresponding functions. The way in which the operating method of this embodiment executes these operations and accomplishes these functions can be readily appreciated by those of ordinary skill in the art based on the explanations of the preceding embodiments, and thus will not be further described herein.

According to the above descriptions, the present invention provides a small cell communication system and an operating method thereof. Specifically, the present invention provides a novel approach to associate an adaptive PRB bundling size with a reference signal pattern for channel estimation. Whether the reference signal pattern indicates the reduction of reference signals due to the improvement of spectral efficiency or indicates the increase of reference signals due to improvement of channel estimation, a suitable PRB bundling size can be determined to correspond to the reference signal pattern in a proper way. Besides, if the reference signal pattern indicates that the distribution of reference signals is changed without decreasing or increasing the amount of reference signals, a suitable PRB bundling size can be determined to correspond to the reference signal pattern in a proper way. Therefore, the present invention can effectively balance channel estimation accuracy and spectral efficiency improved by reducing reference signals under small cell deployment.

The present invention also implies other benefits. For example, if a reference signal pattern indicates the reduction of reference signals, some signals indicating the reduction are inevitable to be transmitted to the corresponding mobile device so that no additional signal overhead is required as the proposed approach is applied. In addition, the channel estimation can be improved by enlarging of the PRB bundling size if the reduction of reference signals is made due to the improvement of spectral efficiency.

The above disclosure is related to the detailed technical contents and inventive features thereof. Persons skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

The term “user equipment” (UE) in this disclosure could represent various embodiments which for example could include but not limited to a mobile station, an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a musical device, a wireless sensor, and so like. In some applications, a UE may be a fixed computer device operating in a mobile environment, such as a bus, train, an airplane, a boat, a car, and so forth.

From the hardware perspective, a UE may include at least but not limited to: a transmitter circuit, a receiver circuit, an analog-to-digital (A/D) converter, a digital-to-analog (D/A) converter, a processing circuit, one or more antenna units, and optionally a memory circuit. The memory circuit may store programming codes, device configurations, buffered or permanent data, codebooks, and etc. . . . . The processing circuit may also be implemented with either hardware or software and would be considered to implement the mechanisms, functions, processes or procedures, and method steps of embodiments of the present disclosure. The function of each element of a UE is similar to a control node and therefore detailed descriptions for each element will not be repeated.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A small cell communication system, comprising:
a base station, configured to determine a reference signal pattern from a plurality of reference signal patterns, determine a physical resource block (PRB) bundling size corresponding to the reference signal pattern and transmit a signal with the PRB bundling size and the reference signal pattern; and
a mobile device, configured to receive the signal and perform channel estimation according to the PRB bundling size and the reference signal pattern.

2. The small cell communication system as claimed in claim 1, wherein the reference signal pattern indicates the amount of reference signals in one PRB and the PRB bundling size is at least one PRB; and wherein the less the reference signal is used in one PRB, the more the PRB is bundled.

3. The small cell communication system as claimed in claim 1, wherein the reference signal pattern indicates the amount of reference signals in one PRB and the PRB bundling size is at least two PRBs; and wherein the less the reference signal is used in one PRB, the more the PRB is bundled.

4. The small cell communication system as claimed in claim 1, wherein the reference signal pattern indicates the amount of reference signals in one PRB and the PRB bundling size is at least one PRB; and wherein the more the reference signal is used in one PRB, the less the PRB is bundled.

5. The small cell communication system as claimed in claim 1, wherein the reference signal pattern indicates the amount of reference signals in one PRB and the PRB bundling size is at least two PRBs; and wherein the more the reference signal is used in one PRB, the less the PRB is bundled.

6. The small cell communication system as claimed in claim 1, wherein the reference signal pattern indicates the distribution of reference signals and the PRB bundling size is determined according to the distribution of reference signals.

7. The small cell communication system as claimed in claim 1, wherein the mobile device further executes channel interpolation according to the reference signal pattern and the PRB bundling size to perform the channel estimation.

8. An operating method for a small cell communication system, the small cell communication system comprising a base station and a mobile device, the operating method comprising the following steps:
determining a reference signal pattern from a plurality of reference signal patterns by the base station;
determining a physical resource block (PRB) bundling size corresponding to the reference signal pattern by the base station;
transmitting a signal with the PRB bundling size and the reference signal pattern by the base station;
receiving the signal by the mobile device; and
performing channel estimation according to the PRB bundling size and the reference signal pattern by the mobile device.

9. The operating method as claimed in claim 8, wherein the reference signal pattern indicates the amount of reference signals in one PRB and the PRB bundling size is at least one PRB; and wherein the less the reference signal is used in one PRB, the more the PRB is bundled.

10. The operating method as claimed in claim 8, wherein the reference signal pattern indicates the amount of reference signals in one PRB and the PRB bundling size is at least two PRBs; and wherein the less the reference signal is used in one PRB, the more the PRB is bundled.

11. The operating method as claimed in claim 8, wherein the reference signal pattern indicates the amount of reference signals in one PRB and the PRB bundling size is at least one PRB; and wherein the more the reference signal is used in one PRB, the less the PRB is bundled.

12. The operating method as claimed in claim 8, wherein the reference signal pattern indicates the amount of reference signals in one PRB and the PRB bundling size is at least two PRBs; and wherein the more the reference signal is used in one PRB, the less the PRB is bundled.

13. The operating method as claimed in claim 8, wherein the reference signal pattern indicates the distribution of reference signals and the PRB bundling size is determined according to the distribution of reference signals.

14. The operating method as claimed in claim 8, wherein the step of performing the channel estimation further comprises the following step:
executing channel interpolation according to the reference signal pattern and the PRB bundling size by the mobile device to perform the channel estimation.
